(19) United States
(12) Patent Application Publication
(10) Pub. No.: US 2016/0114834 A1
(43) Pub. Date: Apr. 28, 2016

(54) STRUCTURE FOR UPPER PART OF VEHICLE BODY

(71) Applicant: HONDA MOTOR CO., LTD., Tokyo (JP)

(72) Inventor: Noritaka Kobayashi, Saitama (JP)

(21) Appl. No.: 14/890,976

(22) PCT Filed: Apr. 25, 2014
(86) PCT No.: PCT/JP2014/061800

§ 371 Date: Nov. 13, 2015

(30) Foreign Application Priority Data
May 16, 2013 (JP) 2013-104319

(51) Int. Cl. B62D 25/06; B62D 27/02; B62D 25/04

(52) U.S. Cl. CPC B62D 25/06; B62D 25/04; B62D 27/023

(57) ABSTRACT

Provided is a structure for an upper part of a vehicle body, the structure being formed by a rail inner, an rail outer joined to a vehicle outer side of the rail inner to form a closed cross-section, and a rail stiffener sandwiched between the rail inner and the rail outer to partition the closed cross-section, the structure being provided with a roof side rail extended in a front-rear direction on an upper side of a side part of a vehicle body, the structure including: a fastened portion attached to a vehicle outer side of the rail stiffener; a collar interposed between the rail inner and the rail stiffener; and a fastening unit inserted through the collar from a vehicle inner side of the rail inner and fastened to the fastened portion.

### TECHNICAL FIELD

The present invention relates to a structure for an upper part of a vehicle body of a vehicle.

### BACKGROUND ART

In general, an upper part of a vehicle body of a vehicle is provided with a roof panel; a plurality of roof rails extending on a lower surface of the roof panel in a vehicle transverse direction and holding the roof panel; roof side rails joined to the both end portions of the roof rails and extended in a vehicle body front-rear direction of the vehicle body; and pillars, whose upper end portions are joined to the roof side rails, extending downward.

As a conventional structure for an upper part of a vehicle body, for example, a roof structure for a vehicle body is known, which is disclosed in Patent Literature 1. In this roof structure of a vehicle body, welded are an outer panel forming a recessed portion with a roof panel in a vertical cross-sectional view; an inner panel joined to a vehicle inner side of the outer panel and forming a closed cross-section; a stiffener forming a closed cross-section between the outer panel and the inner panel; and a reinforcing member (a bulkhead portion) whose cross section is substantially U-shaped joined to the vehicle inner side of the stiffener and forming a closed cross-section. Thus, the stiffness of a joint portion of the roof side rails and the roof rails is increased.

This reinforcing member is disposed on a lower side of the recessed portion formed on the roof panel through an opening formed between the substantially U-shaped cross-section of an extending piece and the lower surface of the stiffener. The reinforcing member is welded at one end thereof to the extending piece, and the bulkhead portion of the other end is welded to an inner lower surface of the inner panel.

### RELATED ART DOCUMENT

### Patent Literature

Patent Literature 1: JP2006-327399A (FIG. 4 and FIG. 5)

### DISCLOSURE OF THE INVENTION

### Problems to be Solved by the Invention

However, although, in the structure for the upper part of the vehicle body (roof structure) disclosed in Patent Literature 1, the reinforcing member is provided at the joint portion between the roof side rail and the roof rail to increase the stiffness of the joint portion, the stiffness and the strength may be decreased because an opening through which the reinforcing member passes the stiffener.

Further, although the strength of the closed cross-section formed by joining the outer panel to the inner panel is increased by the existence of the stiffener, there is a problem that the strength in the vehicle transverse direction and the upper-lower direction is decreased because the outer panel is formed substantially in U-shape in a vertical cross-sectional view.

Further, in the closed cross-section formed by lapping the reinforcing member inside the stiffener, the stiffener and the reinforcing member are formed in a leg straddled trapezoidal shape in a vertical cross-sectional view, and the base end portions are not lapped. Consequently, there is a problem that the closed cross-section is easily deformed in the horizontal direction with respect to the leg portion, and the stiffness and the strength are decreased.

In this situation, a structure for an upper part of a vehicle body, the structure having roof side rails with further increased stiffness and strength, has been desired.

In this situation, the present invention has been developed to solve the above-described problems, and an object of the present invention is to provide a structure, for an upper part of a vehicle body, with increased stiffness and strength of a roof side rail.

### Means for Solving the Problems

In order to solve the above-described problems, according to the present invention, a structure for an upper part of a vehicle body, the structure being formed by a rail inner, an rail outer joined to a vehicle outer side of the rail inner to form a closed cross-section, and a rail stiffener sandwiched between the rail inner and the rail outer to partition the closed cross-section, the structure being provided with a roof side rail extended in a front-rear direction on an upper side of a side part of a vehicle body, includes: a fastened portion attached to a vehicle outer side of the rail stiffener; a collar interposed between the rail inner and the rail stiffener; and a fastening unit inserted through the collar from a vehicle inner side of the rail inner and fastened to the fastened portion.

According to the above structure, as the structure for an upper part of a vehicle body includes the fastening unit that is inserted through a collar from the vehicle inner side of the rail inner and fastened to the fastened portion, the collar is disposed on the inner wall in the closed cross-section formed by the rail inner and the rail stiffener, in a beam form such as to bridge the rail inner and the rail stiffener. Accordingly, it is possible to increase the stiffness and the strength of the roof side rail and to suppress deformation of the closed cross-section.

Further, also in a case of adopting an assembling process in which an outer composition to which the rail stiffener and the rail outer are joined in advance, as the fastening unit can be fastened to the fastened portion provided on the vehicle outer side of the rail stiffener from the vehicle inner side of the rail inner, the workability and the work efficiency of assembling work can be improved.

Further, it is preferable that the rail stiffener is divided in the plurality of rail stiffeners in a front-rear direction and provided with a lap portion at which the divided rail stiffeners are lapped with each other in a vehicle transverse direction; and the fastened portion is attached to a vehicle outer side of the lap portion.

According to the above structure, as the rail stiffener is divided in the plurality of rail stiffeners in the front-rear direction, and the collar is disposed at a position corresponding to the lap portion where the divided stiffeners lap with each other in the vehicle transverse direction, it is possible to increase the stiffness and the strength of the roof side rail due to the lapping of the rail stiffeners.

Still further, it is preferable that the roof side rail includes a pillar extending downward; and the roof stiffener includes: a first rail stiffener joined to the pillar, a front end thereof being extended forward beyond the pillar and a rear end thereof being extended backward beyond the pillar; a second rail stiffener extended forward from the first tail stiffener, a rear end thereof being lapped in the vehicle transverse direction with the front end of the first rail stiffener and joined such as to form the lap portion; and a third rail stiffener extended backward from the first rail stiffener, a front end thereof being lapped with the rear end of the first rail stiffener in the vehicle transverse direction and joined such as to form the lap portion.

According to the above structure, the roof side rail is provided with the first rail stiffener joined to the pillar, wherein the front end of the first rail stiffener is extended forward beyond the pillar, and the rear end of the first stiffener is extended backward beyond the pillar. Thus, the joint portion between the roof side rail and the pillar is not divided. Accordingly, it is possible to increase the stiffness and the strength of the joint portion. Further, as the joint portion between the first rail stiffener and the pillar is provided with the fastening portion such that the lap portion and the collar are sandwiched from the both sides in the vehicle transverse direction, it is possible to further increase the stiffness and the strength of the joint portion.

Yet further, it is preferable that one end of the collar is joined to the vehicle inner side of the rail stiffener and the fastening unit is fastened to the fastened portion so that the other end of the collar contacts the rail inner.

According to the above structure, by joining the collar to the rail stiffener, the position accuracy of the fastened portion and the collar in assembling can be improved. Accordingly, in fastening the fastening unit to the fastened portion, as the fastening unit can be avoided from coming in contact with the collar and becoming into a loaded state, it is possible to accurately apply a fastening torque and an axial force.

Further, it is preferable that the collar is joined to the rail stiffener by projection welding.

According to the above structure, the collar is joined to the rail stiffener by projection welding, and it is thereby possible to easily attain the accuracy of joint position of the collar

Still further, it is preferable that the fastened portion is formed by a nut, and the fastening unit is formed by a bolt screw-engaged with the nut.

Since the fastened portion is formed by a nut and the fastening unit is formed by a bolt, the fastened portion can be fastened to the fastening unit easily.

### Advantage of the Invention

A structure for an upper part of a vehicle body according to the invention can further increase the stiffness and the strength of a roof side rail.

### BRIEF DESCRIPTION OF THE DRAWINGS

FIG. 1 is a schematic side view of the main part of a vehicle body showing an example of a structure for the upper part of a vehicle body in an embodiment of the present invention;

FIG. 2 is an enlarged view of part A in FIG. 1;

FIG. 3 is a B-B cross-sectional view (D-D cross-sectional view) of FIG. 2;

FIG. 4 is an enlarged vertical cross-sectional view of the main part showing a state that a collar is joined to a first rail stiffener; and

FIG. 5 is an enlarged vertical cross-sectional view of a main part showing a modified example of the structure for the upper part of a vehicle body in an embodiment according to the present invention, showing a state that a collar is joined to a rail inner.

### EMBODIMENT FOR CARRYING OUT THE INVENTION

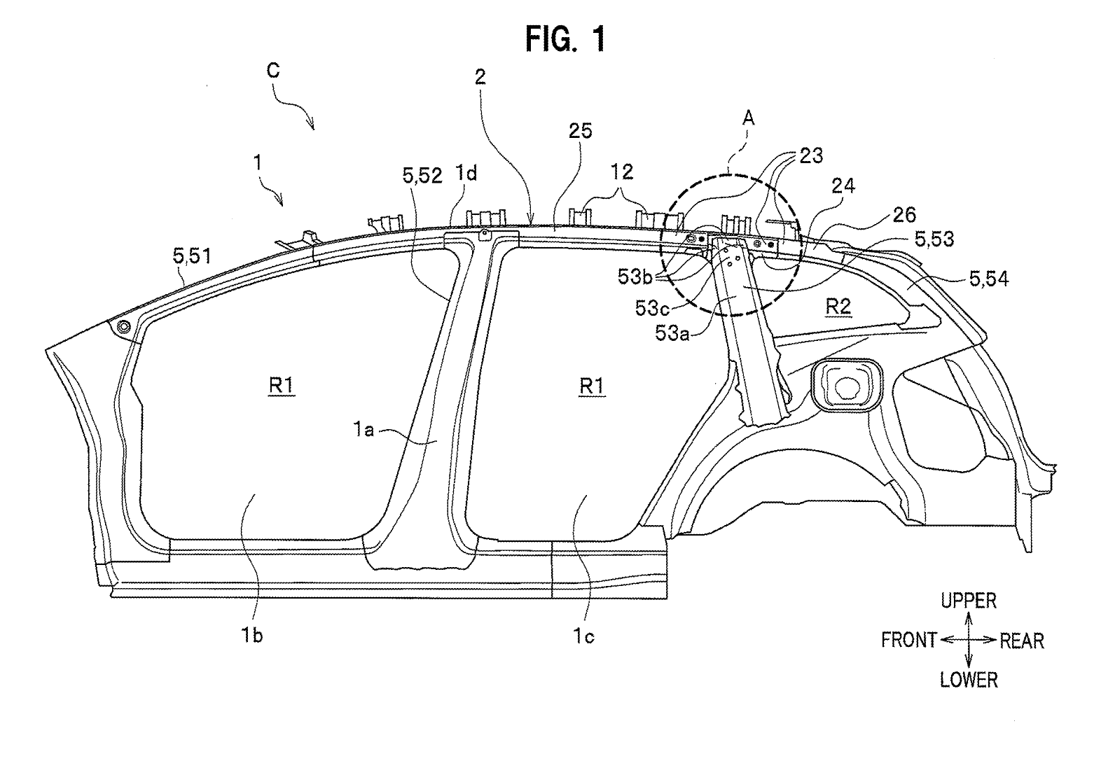

A structure for the upper part of a vehicle body in an embodiment according to the present invention will be described below, referring to FIGS. 1 to 4.

Incidentally, in the present embodiment according to the invention, “front” represents the front side of a vehicle C, “rear” represents the rear side of the vehicle C, “upper” represents the vertically upper side, and “lower” represents the vertically lower side.

### <Structure of Vehicle>

First, before describing the structure for the upper part of a vehicle body in the present embodiment according to the invention, the vehicle C, for which the structure for the upper part of a vehicle body according to the invention is adopted, will be described.

As shown in FIG. 1, the vehicle C is provided with roof side rails 2 arranged at the left and right ends of roof rails 12 extended in the vehicle transverse direction and pillars 5 extended downward from the roof side rails 2. The kind, shape, and the like of the vehicle C are not particularly limited. That is, as long as the vehicle C is provided with roof side rails 2 and pillars 5 on a vehicle body 1, the vehicle C may be a passenger car, a bus, a truck, a work vehicle, or the like. In the following, a four door passenger vehicle will be described as an example of the vehicle C.

### <Structure of Vehicle Body>

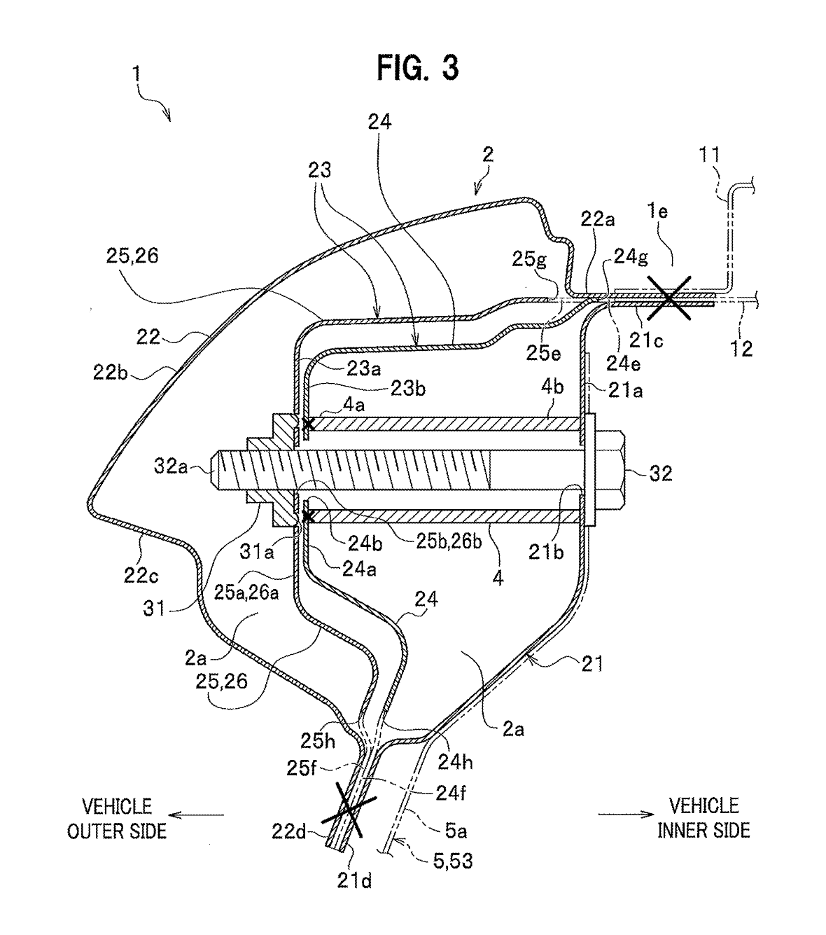

As shown 1, the vehicle body 1 includes frame members for forming the entirety of the vehicle C, and is provided with, for example, various metal vehicle body frames such as the roof side rails 2 described later and the like, a metal vehicle body panel such as a roof panel 11 (see FIG. 3), and the like. Each of vehicle body side portions 1a on the both sides of the vehicle body 1 is provided with a door opening portion 1b at a front seat and a door opening portion 1c at a rear seat.

Incidentally, as the vehicle body side portions 1a are formed substantially left-right symmetrically, the passenger seat (left side) will be mainly described, and description of the driver's seat (right side) will be omitted.

### <Structure of Upper Part of Vehicle Body>

As shown in FIG. 1, a vehicle body upper part 1d is an upper part of the entirety of the vehicle body 1 and is mainly configured by the roof panel 11 (see FIG. 3) constructing the portion of the roof of the vehicle body 1, and members constructing the frames near the left and side portions. The roof portion of the vehicle body 1 is provided with the above-described roof panel 11, the roof rails 12 under the roof panel 11, and the pillars 5 extended downward from the roof rails 12.

### <Structure of Pillar>

As shown in FIG. 1, the pillars 5 include, for example, front pillars 51, center pillars 52, quarter pillars 53, and rear pillars 54.

The front pillars 51 are posts provided on the left and the right of a front glass (not shown).

The center pillars 52 are posts provided between the respective door opening portions 1b and the door opening portions 1c.

The quarter pillars 53 are posts provided on the rear side of the door opening portions 1c.

The rear pillars 54 are posts provided from the upper portion of a luggage room R2 toward the rear end portion of the vehicle body 1.

### <Structure of Roof Panel>

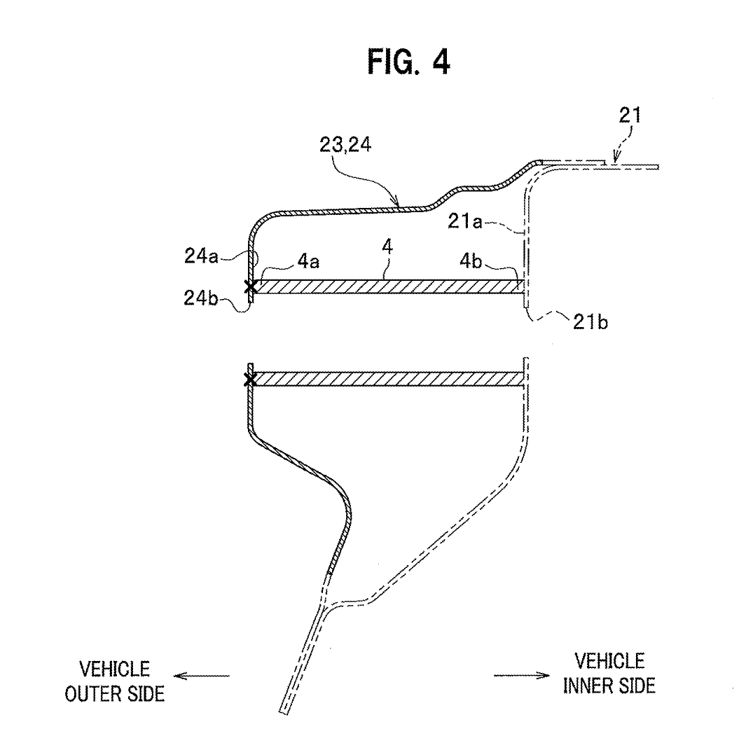

As shown in FIG. 3, the roof panel 11 is a plate member forming the roof of the vehicle body 1 and is a metal plate such as a rolled steel plate or the like formed substantially in a rectangular shape in plan view. Each of the left and right end portions of the roof panel 11 forms a half portion of a recessed portion 1e bent in a recessed shape in front view. The roof panel 11 is connected and fixed at the bottom face portion of the recessed portion 1e by spot welding, wherein the rail outer 22 of the roof side rail 2, the roof rail 12, and a rail inner 21 of the roof side rail 2 are lapped. Incidentally, mark X in FIG. 3 and FIG. 4 represents the welding portions.

### <Structure of Roof Rail>

As shown in FIG. 1, the roof rails 12 are members supporting the roof panel 11 (see FIG. 3) from the lower side and are arranged such as to bridge the left and right roof side rails 2, 2. The plurality of roof rails 12 are arranged the front end portion to the rear end portion of the roof side rail 2 at appropriate intervals. As shown in FIG. 3, the left and right end portions of the roof rails 12 are sandwiched by the later-described rail inners 21 and the rail outers 22.

### <Structure of Roof Side Rail>

As shown in FIG. 1, the roof side rails 2 are frame members disposed, extending in the front-rear direction on the upper side of the vehicle body side portions 1a, and the plurality of pillars 5 are joined to the roof side rails 2 at the upper end portions thereof, extending downward. The roof side rails 2 are extended in the front-rear direction of the vehicle body, and form the door opening portions 1b, 1c, and the upper edge of the luggage room R2.

In the following, as an example of the present invention, the roof side rail 2 at the portion where the quarter pillar 53 (also referred to as “C pillar”) is arranged will be described, wherein the quarter pillar 53 is disposed on the vehicle body side portion 1a of the vehicle body upper part 1d at a position posterior to the central portion of the left side of the vehicle C.

As shown in FIG. 3, the roof side rail 2 is configured by the rail inner 21, the rail outer 22 joined to the vehicle outer side of the rail inner 21, a rail stiffener 23 sandwiched between the rail inner 21 and the rail outer 22, a fastened portion 31 attached to the vehicle outer side of the rail stiffener 23, a collar 4 interposed between the rail inner 21 and the rail stiffener 23, and a fastening unit 32 fastened to the fastened portion 31.

### <Structure of Rail Inner>

As shown in FIG. 3, the rail inner 21 is a member arranged perpendicular to the upper end portion of a pillar inner 5a to hold the roof panel 11 and the roof rail 12. The rail inner 21 includes an inner side wall portion 21a disposed on the vehicle inner side of the rail outer 22, a fastening member insertion hole 21b formed through the inner side wall portion 21a, an inner upper flap portion 21c bent substantially horizontally toward the vehicle body inner side from the upper portion of the inner side wall portion 21a, and an inner lower flap portion 21d bent in an inclined state downward from the lower portion of the inner side wall portion 21a.

The rail inner 21 is joined, at the inner upper flap portion 21c of the upper end portion thereof and the inner lower flap portion 21d of the lower end portion thereof, to the rail outer 22 to form a closed cross-section 2a with the rail outer 22 in a vertical cross-sectional view. The rail inner 21 is a half portion that forms a tubular frame member with the rail outer 22.

A head portion of the fastening unit 32 formed by a bolt with a seat inserted in the fastening member insertion hole 21b is disposed at the inner side wall portion 21a of the rail inner 21. Further, the upper end portion of the pillar inner 5a is joined to the vehicle inner side of the inner side wall portion 21a. The fastening unit 32 inserted in the fastening member insertion hole 21b of the inner side wall portion 21a inserts through the collar 4, a first rail stiffener 24, a second rail stiffener 25 (or a third rail stiffener 26) and is screw-engaged by the fastened portion 31 formed by a nut. In such a manner, the first rail stiffener 24 and the second rail stiffener 25 are fixed to the surface on the vehicle outer side of the inner side wall portion 21a through the collar 4 by the fastening unit 32 and the fastened portion 31.

The fastening member insertion hole 21b is formed with a diameter larger than the outer diameter of the male screw portion 32a of the fastening unit 32 and smaller than the inner diameter of the collar 4, and is arranged in a state that the end portion of the collar 4 is in contact with the outer circumference of the fastening member insertion hole 21b on the vehicle outer side of the rail inner 21.

### <Structure of Rail Outer>

As shown in FIG. 3, the rail outer 22 is a member, of the roof side rail 2, disposed on the outermost side of the vehicle to form the vehicle body outer-side portion, and is extended in the vehicle body front-rear direction. The rail outer 22 includes an outer upper flap portion 22a arranged substantially horizontally to form the inner bottom portion of the recessed portion 1e, an upper inclined wall portion 22b bent with outward and downward inclination from the opening end of the recessed portion 1e, a lower inclined wall portion 22c bent with inward and downward inclination from the lower portion of the upper inclined wall portion 22b, and an outer lower flap portion 22d bent with outward and downward inclination from the lower portion of the lower inclined wall portion 22c.

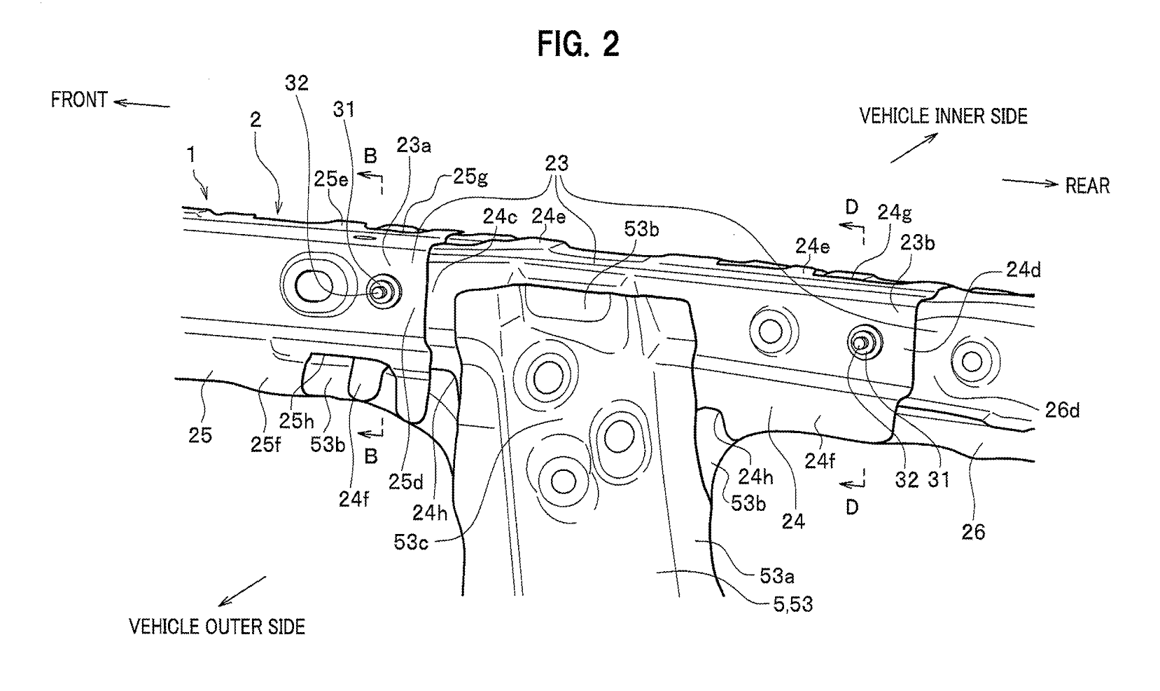

The rail outer 22 and the rail inner 21 form the closed cross-section 2a. The first rail stiffener 24 and the second rail stiffener 25 (or the third rail stiffener 26 (see FIG. 2)) are arranged between the rail outer 22 and the rail inner 21.

The outer upper flap portion 22a is spot-welded in a state that the roof panel 11 and the inner upper flap portion 21c are lapped at the recessed portion 1e. The outer lower flap portion 22d is spot-welded to the inner lower flap portion 21d and the upper end portion of the pillar inner 5a.

### <Structure of Rail Stiffener>

As shown in FIG. 3, the rail stiffener 23 is a member sandwiched between the rail inner 21 and the rail outer 22 to partition the closed cross-section 2a with respect to the vehicle transverse direction, and is formed from a rolled steel plate extended in the vehicle body front-rear direction. As shown in FIG. 2, the rail stiffener 23 is formed by members divided in three in the front-rear direction and is provided with lap portions 23a, 23b lapping in the vehicle transverse direction. That is, the rail stiffener 23 includes the first rail stiffener 24 joined to the pillar 5, the second rail stiffener 25 extended forward from the first rail stiffener 24, and the third rail stiffener 26 extended backward from the first rail stiffener 24.

As shown in FIG. 2, the lap portions 23a, 23b are arranged at the front end portion 24c and the rear end portion 24d of the first rail stiffener 24. The lap portion 23a is a portion arranged such that the front end portion 24c of the first rail stiffener 24 and the rear end portion 25d of the second rail stiffener 25 are lapped with each other, and is fastened by a fastening unit 32 and a fastened portion 31.

The lap portion 23b is a portion arranged such that the rear end portion 24d of the first rail stiffener 24 and the front end portion 26d of the third rail stiffener 26 are lapped with each other in the vehicle transverse direction, and is fastened by a fastening unit 32 and a fastened portion 31.

### <Structure of First Rail Stiffener>

As shown in FIG. 2, the first rail stiffener 24 is a member that is arranged perpendicular to the vehicle inner side of the upper end portion 53c of the quarter pillar 53 (pillar 5), extended in the vehicle body front-rear direction, and formed by a rolled steel plate. The front end portion 24c of the first rail stiffener 24 is extended forward beyond the quarter pillar 53, and the rear end portion 24d of the first rail stiffener 24 is extended backward beyond the quarter pillar 53.

As shown in FIG. 3, the first rail stiffener 24 is formed substantially in a C-shape in a vertical cross-sectional view and is provided with a fastening member insertion hole 24b through a vertical outer wall portion 24a. The first rail stiffener 24 is arranged such that the upper end portion 24e thereof is extended to the recessed portion 1e to be joined to the inner upper flap portion 21c and the like, and the lower end portion 24f is extended to the joint portion between the inner lower flap portion 21d and the outer lower flap portion 22d to be joined to the inner lower flap portion 21d and the like. The upper end portion 24e and the lower end portion 24f of the first rail stiffener 24 are provided respectively with cut-out portions 24g, 24h for enabling spot welding in a state that the upper end portion 25e and the lower end portion 25f of the second rail stiffener 25 disposed on the vehicle outer side of the first rail stiffener 24 are directly in contact with the rail inner 21 disposed on the inner side of the second rail stiffener 25. The front end portion 24c and the rear end portion 24d of the first rail stiffener 24 are provided respectively with fastening member insertion holes 24b (see FIG. 4).

The fastening member insertion hole 24b has a diameter larger than the outer diameter of a male portion 32a of the fastening unit 32 and smaller than the inner diameter of the collar 4. The end portion of the collar 4 is joined to the outer circumference of the fastening member insertion hole 24b on the vehicle inner side of the first rail stiffener 24. Incidentally, a protrusion (not shown) which is press-crushed by an electrode at the time of projection welding is formed at a region around the fastening member insertion hole 24b where the collar 4 is joined to the region.

The cut-out portions 24g, 24h are formed being cut out in a recessed shape at the upper and lower flange portions of the first rail stiffener 24, and are formed for example at a plurality of positions on the upper end portion 24e of the first rail stiffener 24 and at a position, in the vicinity of the quarter pillar 53, of the lower end portion 24f.

### <Structure of Second Rail Stiffener>

As shown in FIG. 2, the second rail stiffener 25 is a member whose rear end portion 25d laps with the front end portion 24c of the first rail stiffener 24 with respect to the vehicle transverse direction to form the lap portion 23a. The second rail stiffener 25 is formed by a rolled steel plate extended in the vehicle body front-rear direction, and is formed substantially in a C-shape in a vertical cross-sectional view. As shown in FIG. 3, the second rail stiffener 25 is disposed such as to lap with the vehicle outer side of the first rail stiffener 24. The second rail stiffener 25 is arranged such that the upper end portion 25e is extended to the recessed portion 1e to be joined to the inner upper flap portion 21c and the like and the lower end portion 25f is extended to the joint portion between the inner lower flap portion 21d and the outer lower flap portion 22d to be joined to the inner lower flap portion 21d and the like. The upper end portion 25e and the lower end portion 25f of the second rail stiffener 25 are provided with cut-out portions 25g, 25h which allow the upper end portion 24e and the lower end portion 24f of the first rail stiffener 24 disposed on the vehicle inner side of the second rail stiffener 25 to be exposed to the vehicle outer side and to be directly welded by the electrode of spot welding.

A vertical outer wall portion 25a is provided with a fastening member insertion hole 25b.

The fastening member insertion hole 25b is formed with a diameter larger than the outer diameter of the male screw portion 32a of the fastening unit 32 and smaller than the inner diameter of the collar 4, and the fastened portion 31 is attached to the outer circumference of the fastening member insertion hole 25b on the vehicle outer side of the second rail stiffener 25.

The cut-out portions 25g, 25h are formed in a recessed shape at the upper and lower flange portions of the second rail stiffener 25 similarly to the above-described cut-out portions 24g, 24h, and are formed for example at a plurality of positions on the upper end portion 25e of the second rail stiffener 25 and a position adjacent to the quarter pillar 53 of the lower end portion 25f.

### <Structure of Third Rail Stiffener>

As shown in FIG. 2, a front end of the third rail stiffener 26 is joined to the rear end of the first rail stiffener 24 in the vehicle transverse direction to form the lap portion 23a. The third rail stiffener 26 is formed by a rolled steel plate extended in the vehicle body front-rear direction.

The third rail stiffener 26 has a cross-section taken along the arrow D-D shown in FIG. 2 substantially in the same shape as that of the second rail stiffener 25 shown in FIG. 3, and is disposed at a symmetrical position. Similarly to the second rail stiffener 25, the third rail stiffener 26 is fixed by a fastening unit 32, a collar 4, and a fastened portion 31. That is, the third rail stiffener 26 is provided with an outer wall portion 26a and a fastening member insertion hole 26b, which respectively correspond to the outer wall portion 25a and the fastening member insertion hole 25b of the above-described second rail stiffener 25.

### <Structure of Fastened Portion>

As shown in FIG. 3, the fastened portion 31 is a member that is attached to the respective vehicle outer side of the lap portions 23a, 23b and is screw-engaged with the male screw portion 32a of the fastening unit 32. The fastened portion 31 is formed by a nut with a seat having a convex portion 31a press-crushed for example by the electrode in projection welding. Incidentally, the shape of the fastened portion 31 is not particularly limited as long as the fastened portion 31 is a member fastened by the fastening unit 32.

### <Structure of Fastening Unit>

The fastening unit 32 is a member that penetrates through the collar 4 from the vehicle inner side of the rail inner 21 to be fastened to the fastened portion 31, and is formed for example by a bolt having a male screw portion 32a. The male screw portion 32a is screw-engaged with the fastened portion 31.

### <Structure of Collar>

The collar 4 is made of a cylindrical metal member, whose one end is joined to the vehicle inner side of the rail stiffener 23 and the other end is touched to the rail inner 21 by fastening the fastening unit 32 to the fastened portion 31. The collar 4 is joined for example to the vehicle inner side surface of the rail stiffener 23 by projection welding.

The collar 4 is interposed between the combination of the first rail stiffener 24 and the second rail stiffener 25 (the third rail stiffener 26), which are lapped with each other inside the closed cross-section 2a formed by the rail inner 21 and the rail outer 22, and the collar 4 bridges the fastening unit 32 and the fastened portion 31. In such a manner, the fastening unit 32, the fastened portion 31, and the collar 4 are arranged as members that inhibit deformation of the closed cross-section 2a and thereby improving the stiffness and the strength.

### <Structure of Quarter Pillar Stiffener>

As shown in FIG. 2, a quarter pillar stiffener 53a is a reinforcing member constructing the core member of the quarter pillar 53, which is in a post shape forming a part of the vehicle body side portion 1a and the vehicle body upper part 1d, and is formed for example by pressing a rolled steel plate. The quarter pillar stiffener 53a is interposed between a quarter pillar inner (not shown) and a quarter pillar outer (not shown) in a tube shape extended downward from the roof side rail 2, and these are integrated, being joined by spot welding or the like. The upper side circumference, in the front-rear direction, of the upper end portion 53c of the quarter pillar stiffener 53a is provided with a flange portion 53b joined to the rail stiffener 23 by spot welding or the like.

### <Action of Structure for Upper Part of Vehicle Body>

In the following, the action of the structure for the upper part of a vehicle body in the present embodiment according to the invention will be described, referring to the drawings mainly FIG. 4.

As shown in FIG. 4, the circumferential outer wall portion 24a of the fastening member insertion hole 24b of the first rail stiffener 24 (rail stiffener 23) is joined to the vehicle outer-side end portion 4a on the vehicle outer side of the collar 4 by projection welding. The vehicle inner-side end portion 4b on the vehicle inner side of the collar 4 is arranged in a state of contact with the circumferential inner side wall portion 21a of the fastening member insertion hole 21b of the rail inner 21.

Accordingly, as the vehicle outer-side end portion 4a of the collar 4 is integrated by welding after being aligned to the position of the fastening member insertion hole 24b of the first rail stiffener 24, the joint position accurately determined does not deviate. Consequently, in joining the first rail stiffener 24 and the collar 4, the accuracy of the joint position can be easily obtained.

In attaching the first rail stiffener 24 and the collar 4 to the roof side rail 2, first as shown in FIG. 3, the vehicle inner-side portion 4b of the collar 4 is made in contact with the circumferential inner side wall portion 21a of the fastening member insertion hole 21b. Then, the second rail stiffener 25 (or the third rail stiffener 26) is arranged on the vehicle outer side of the first rail stiffener 24 such that the fastening member insertion hole 25b is aligned with the fastening member insertion hole 24b of the first rail stiffener 24.

Subsequently, the fastened portion 31 is projection welded to the outer wall portion 25a of the second rail stiffener 25 while the convex portion 31a of the fastened portion 31 is being press-crushed by the electrode. Then, the fastening unit 32 is inserted from the vehicle inner side of the rail inner 21 through the fastening member insertion hole 21b of the rail inner 21, the collar 4, the fastening member insertion hole 24b of the first rail stiffener 24, and the fastening member insertion hole 25b of the second rail stiffener 25 to be fastened to the fastened portion 31.

Then, the roof rail 12, the outer upper flap portion 22a of the rail outer 22, and the roof panel 11 are lapped on the inner upper flap portion 21c, and are joined to each other at the recessed portion 1e by spot welding or the like. Then, the inner lower flap portion 21d of the rail inner 21 is joined to the outer lower flap portion 22d of the rail outer 22 by spot welding or the like, and the roof side rail 2 is thereby attached as shown in FIG. 3.

The roof side rail 2 formed in such a manner is arranged in a beam shape such that the collar 4 joined to the first rail stiffener 24 in the closed cross-section 2a formed by the rail inner 21 and the rail stiffener 23 is fixed to the rail inner 21 by the fastening unit 32 and the fastened portion 31. Accordingly, even when an external force is loaded to the roof side rail 2, deformation of the closed cross-section 2a is inhibited by the collar 4, the fastening unit 32, and the fastened portion 31.

Further, the closed cross-section 2a formed by the rail inner 21 and the rail outer 22 is partitioned in two by a member obtained by lapping the first rail stiffener 24 and the second rail stiffener 25 substantially in a C-shape in a vertical cross-sectional view; and the collar 4 joined to the first rail stiffener 24 is fastened to the rail inner 21 by the fastening unit 32 and the fastened portion 31. Consequently, the rail inner 21 can be held by the first rail stiffener 24, the second rail stiffener 25, the collar 4, the fastening unit 32, and the fastening unit 32.

As a result, the stiffness and the strength of the roof side rail 2 can be increased.

The roof side rail 2 is as shown in FIG. 2 joined to the upper end portion 53c of the quarter pillar 53 (pillar 5). The front end of the first rail stiffener 24 of the roof side rail 2 is extended forward beyond the quarter pillar 53, and the rear end of the first rail stiffener 24 is extended backward beyond the quarter pillar 53. As the joint portion where the quarter pillar 53 is joined to the first rail stiffener 24 is not divided in a plurality of members, the quarter pillar 53 can be firmly joined to the first rail stiffener 24. Further, the joint portion between the first rail stiffener 24 and the quarter pillar 53 is provided with a fastening portion (the fastened portion 31 and the fastening unit 32) sandwiching the lap portions 23a, 23b and the collar 4 (see FIG. 3) from the both sides in the vehicle transverse direction. Accordingly, the stiffness and the strength of the joint portion can be further increased.

### Modified Example

Incidentally, the present invention is not limited to the above-described embodiment, and various modifications and changes can be made within the scope of the technical ideas of the invention. It is needless to say that the invention covers such modifications and changes.

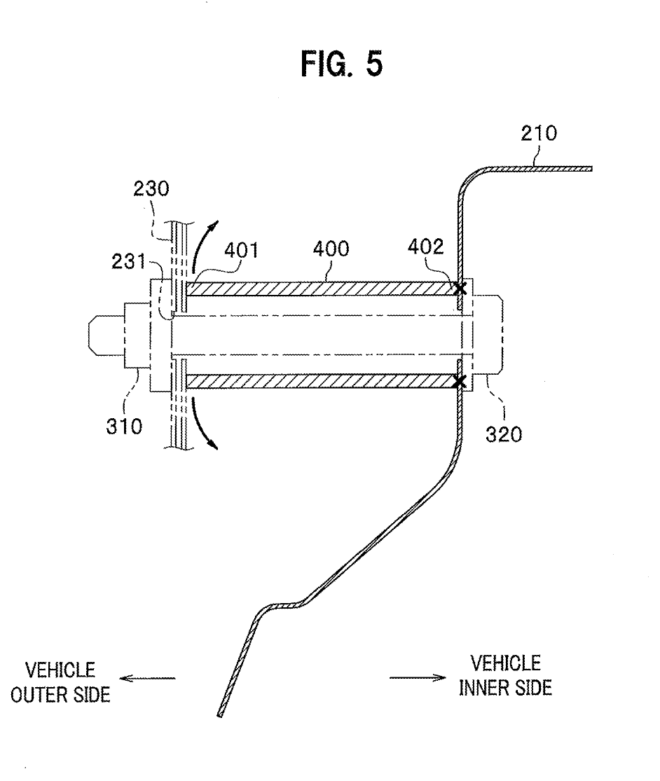

FIG. 5 is a diagram showing a modified example of a structure for an upper part of a vehicle body in an embodiment of the present invention, and is an enlarged vertical cross-sectional view of a main part showing a state that a collar is joined to a rail inner.

In the above-described embodiment, as shown in FIG. 3 and FIG. 4, a case where the vehicle outer-side end portion 4a of the collar 4 is joined to the outer wall portion 24a of the first rail stiffener 24 was taken as an example in the description, however, the vehicle inner-side end portion 402 of a collar 400 may be joined to a rail inner 210, as shown in FIG. 5.

In case that the collar 400 is joined to the rail inner 21, the vehicle outer-side end portion 401 side of the collar 400 becomes a free end, and the vehicle inner-side end portion 402 side, which is the joint portion, becomes a fixed end. If an external force or the like is loaded on the vehicle outer-side end portion 401 of the collar 400, the free end may swing such as to rotate with the vehicle inner-side end portion 402 as the center. Accordingly, in case of joining the collar 400 to the rail inner 210, deviation or the like of due to the swinging makes it difficult to obtain position accuracy. In this case, the swinging of the collar 400 may cause a load in a direction where the free end on the rail stiffener 230 side and the nut 310 separate from each other.

On the other hand, in the above-described embodiment, as shown in FIG. 3 and FIG. 4, as the collar 4 is joined to the first rail stiffener 24, the collar 4 is integrated with the first rail stiffener 24, and the collar 4 accordingly hardly moves and deviates even when an external force is loaded, which attains an excellent functionality.

### Another Modified Example

In the foregoing embodiment, as an example of the present invention, as shown in FIGS. 3 and 4, an example was taken in description where the rail stiffener 23 is attached to the rail inner 21, and the rail outer 22 is thereafter joined to the rail inner 21, however, the invention is not limited thereto.

For example, an assemble process may be adopted in which an outer composition (not shown) assembled by joining the rail stiffener 23 to the rail outer 22 in advance is joined to the rail inner 21. Also in this case, as it is possible to fasten the fastening unit 32 (bolt) from the vehicle inner side of the rail inner 21 to the fastened portion 31 (nut) provided on the vehicle outer side of the rail stiffener 23, it is possible to easily improve the workability and work efficiency of assembling work.

Although the left-side part of the vehicle body upper part at which the roof side rail 2 is joined to the quarter pillar 53 has been described as an example of the present invention, the invention is not limited thereto. For example, as shown in FIG. 1, the invention can also be applied to the joint part between the pillar 5 (i.e., the front pillar 51, the center pillar 52, or the rear pillar 54) and the roof side rail 2.

### DESCRIPTION OF REFERENCE SYMBOLS

1: vehicle body
1a: vehicle body side portion
2: roof side rail
2a: closed cross-section
4, 400: collar
5: pillar
21, 210: rail inner
22: rail outer
23, 230: rail stiffener
23a: lap portion
24: first rail stiffener
25: second rail stiffener
26: third rail stiffener
31, 310: fastened portion
32, 320: fastening unit
51: pillar stiffener
53: quarter pillar

1. A structure for an upper part of a vehicle body, the structure being formed by a rail inner, an rail outer joined to a vehicle outer side of the rail inner to form a closed cross-section, and a rail stiffener sandwiched between the rail inner and the rail outer to partition the closed cross-section, the structure being provided with a roof side rail extended in a front-rear direction on an upper side of a side part of a vehicle body, the structure comprising:
a fastened portion attached to a vehicle outer side of the rail stiffener;
a collar interposed between the rail inner and the rail stiffener; and
a fastening unit inserted through the collar from a vehicle inner side of the rail inner and fastened to the fastened portion.

2. The structure for an upper part of a vehicle body according to claim 1,
wherein the rail stiffener is divided in the plurality of rail stiffeners in a front-rear direction and provided with a lap portion at which the divided rail stiffeners are lapped with each other in a vehicle transverse direction, and
wherein the fastened portion is attached to a vehicle outer side of the lap portion.

3. The structure for an upper part of a vehicle body according to claim 2,
wherein the roof side rail includes a pillar extending downward; and
wherein the roof stiffener includes:
a first rail stiffener joined to the pillar, a front end thereof being extended forward beyond the pillar and a rear end thereof being extended backward beyond the pillar;
a second rail stiffener extended forward from the first tail stiffener, a rear end thereof being lapped in the vehicle transverse direction with the front end of the first rail stiffener and joined such as to form the lap portion; and
a third rail stiffener extended backward from the first rail stiffener, a front end thereof being lapped with the rear end of the first rail stiffener in the vehicle transverse direction and joined such as to form the lap portion.

4. The structure for an upper part of a vehicle body according to claim 1,
wherein one end of the collar is joined to the vehicle inner side of the rail stiffener and the fastening unit is fastened to the fastened portion so that the other end of the collar contacts the rail inner.

5. The structure for an upper part of a vehicle body according to claim 4, wherein the collar is joined to the rail stiffener by projection welding.

6. The structure for an upper part of a vehicle body according to claim 1, wherein the fastened portion is formed by a nut, and the fastening unit is formed by a bolt screw-engaged with the nut.
